(19) United States
(12) Patent Application Publication
(10) Pub. No.: US 2017/0073210 A1
(43) Pub. Date: Mar. 16, 2017

(54) SYSTEM AND METHOD FOR DISPENSING FOOD OIL

(71) Applicant: ECO REFILL SYSTEMS, LLC, Benicia, CA (US)

(72) Inventors: Bernadette Sarouli, American Canyon, CA (US); Lane Landry, Benicia, CA (US)

(21) Appl. No.: 14/856,067

(22) Filed: Sep. 16, 2015

(51) Int. Cl. B67D 7/02; B67D 7/58; B67D 7/42; B67D 7/16; B67D 7/38

(52) U.S. Cl. CPC B67D 7/0294; B67D 7/16; B67D 7/38; B67D 7/42; B67D 7/58; A23D 9/00

(57) ABSTRACT

The present invention relates to a food oil delivery and storage system including: a delivery container, where the delivery container includes a delivery container output for dispensing food oil, and where the delivery container output is in fluid communication with a delivery nozzle; and a storage container including a storage container input configured to receive cooking oil from the delivery nozzle, and storage container input including a removable plug, and a storage container output for dispensing food oil to food preparation equipment, and where the storage container output includes a controllable valve for selectively dispensing food oil to the food preparation equipment; and relates to a method of storing and delivering food oil including providing food oil to a delivery container, transferring food oil from the delivery container to a storage container, and subsequently transferring additional food oil from the delivery container to the storage container.

### FIELD OF THE INVENTION

The present invention relates to a system and method for dispensing food oil or oils, and in particular for re-filling and dispensing oils in a manner that increases efficiency and reduces waste.

### BACKGROUND OF THE INVENTION

Food and cooking oils (collectively referred to herein as “food” oils herein for clarity and convenience), are an integral part of modern food preparation. By way of non-limiting examples, such oils include, for example, soy oil, canola oil, olive oil such as virgin or extra virgin olive oil, olive oil blends, pomace oil, coconut oil such as winterized premium coconut oil, grape seed oil, rice oil, bran oil, corn oil, and blends of any of the above. Commercial use of food oils is extensive. It is estimated that worldwide consumption of food oils will exceed 170 million tons in years 2014 and 2015. Typically, restaurants utilize an average of 400 pounds of oil per week, or over 20,000 pounds per year.

Currently, the provision, storage and use of food oils suffers from several disadvantages. Oil is typically delivered and maintained in one of two packaging arrangements: 35-pound jugs or 1-gallon bottles, the latter of which are typically delivered in cases of six. Handling and moving these heavy containers or cases poses potential injury for drivers and restaurant workers. Storage of the containers can occupy up to eight cubic feet of dry storage space. Perhaps most importantly, disposal of packaging and containers creates significant waste. A restaurant disposing 400 pounds of food oil per week will dispose of hundreds of plastic, metal and/or cardboard containers and boxes per year.

It is desired to have an system for delivery, storage, and provision of food oils that avoids those and other disadvantages, including: handling hot oil, workers compensation claims, spills, added labor costs, lack of security, decreased cleanliness, damaged or lost oil, unsanitary storage, pest problems, and trash and recycling requirements and costs.

### SUMMARY OF THE INVENTION

The present invention overcomes the above and other shortcomings of current credit evaluation and scoring. It can be summarized in the following exemplary aspects.

In one exemplary embodiment of the invention, a food oil delivery and storage system includes: (1) a delivery container, where the delivery container includes a delivery container output for dispensing food oil, and where the delivery container output is in fluid communication with a delivery nozzle; and (2) a storage container including a storage container input disposed on an upper portion of the storage container and configured to receive cooking oil from the delivery nozzle, and storage container input including a removable plug, and a storage container output disposed on a lower portion of the storage container for dispensing food oil to food preparation equipment, and where the storage container output includes a controllable valve for selectively dispensing food oil to the food preparation equipment.

In a second exemplary embodiment of the invention, a method of storing and delivering food oil includes providing food oil to a delivery container, transferring food oil from the delivery container to a storage container, and subsequently transferring additional food oil from the delivery container to the storage container.

### BRIEF DESCRIPTION OF THE DRAWINGS

FIG. 1 is a side view of exemplary steel drum containers for use with the present invention.

FIG. 2 is a side view of an exemplary delivery container for use with the present invention.

FIG. 3 is a side view of an exemplary storage container according to the present invention.

FIG. 3A is a side view of an exemplary valve for use with the present invention.

FIG. 3B is a top view of the exemplary valve of FIG. 3A.

FIG. 3C is a front view of the exemplary valve of FIG. 3A

FIG. 3D is a side view of an exemplary spout for use with the present invention.

FIG. 4 is a top view of the exemplary storage container of FIG. 3.

FIG. 5 is a partial cross-sectional view of the exemplary storage container of FIG. 3.

FIG. 6 is a side view of a further exemplary storage container according to the present invention.

FIG. 7A is a flow chart of an exemplary method according to the present invention.

FIG. 7B is a flow chart of another exemplary method according to the present invention.

### DETAILED DESCRIPTION OF EXEMPLARY EMBODIMENTS

The present invention involves the delivery and/or storage of food oils in a manner that is more efficient, less expensive, safer and more environmentally sound than previous methods. The invention is generally achieved through a re-fillable and re-usable storage container for food oil, which may be filled by a fixed or portable delivery container for food oil. The delivery container in turn may be filled from storage drums, directly from rail car, or by other suitable means. The storage container may be maintained in a commercial facility such as a restaurant, and may provide a convenient supply of food oil as useful or necessary, without need to handle or discard boxes, jars, containers or the like.

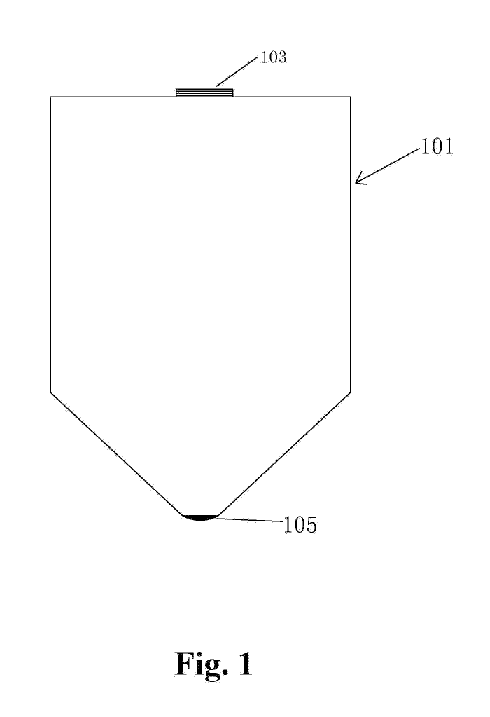

In general, food oil is provided to a delivery container for use with the present invention, and then transferred to a storage container for use with the present invention. FIG. 1 shows one exemplary mechanism for providing food oil to a storage container, in particular storage drum 101 that may be used to store food oil that has been delivered in bulk. Preferably, storage drum 101 is formed of stainless steel or another useful material that can withstand the fluid pressure and maintain food oil without undue spoilage or contamination. In a preferred embodiment, storage drum includes a storage drum input 103 to receive food oil, and a storage drum output 105 to dispense food oil, for example to a delivery container as described herein. In a particularly preferred embodiment, storage drum 101 includes input 103 at an upper portion of storage drum 101, and output 105 at a lower portion of storage drum 101. It is understood that multiple storage drums 101 may be utilized with the present invention.

Storage drum 101 may, for example, be located in proximity to a railway station or truck depo (not shown), so that food oil may be delivered by rail car, truck or other large shipping container in bulk and deposited directly in storage drum 101. Any useful or convenient rail car mechanism as known in the art may be utilized to transport food oil. Alternatively, any known truck or roadway mechanism may be used to transport food oil may to storage drum 101 (e.g., trailer). Alternatively, any other useful mechanism known to transport fluids may be utilized to delivery food oil to storage drum 101. Further, any known mechanism may be utilized to transfer food oil from rail car or truck (or other transportation means) to storage drum 101.

It is understood, however, that storage drum 101 need not be utilized. Instead, food oil may be provided to storage container 201 (described below) directly from any of the transport means described above or otherwise known.

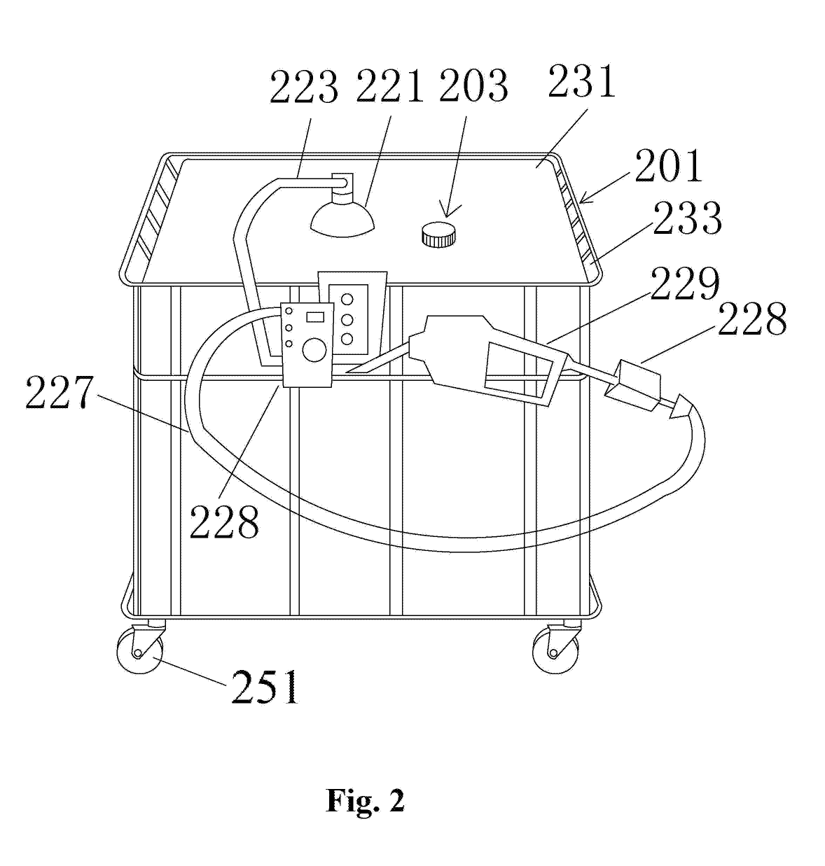

FIG. 2 shows an exemplary delivery container 201 according to and for use with the present invention. Delivery container 201 may be any useful size, for example holding between 200 and 4000 liters of food oil, and more preferably between 400 and 2000 liters of food oil. In a preferred embodiment, delivery container 201 is a “2100 pound” container that can hold approximately 272 gallons, or approximately 1,030 liters of food oil. It is understood that the term “delivery container” is utilized herein for convenience only. In some embodiments of the invention, one or more delivery containers 201 may be transported to restaurants or other locations to provide food oil to one or more storage containers 301. In other embodiments, one or more storage containers 301 may be transported to one or more delivery containers 201 for the provision of oil to the storage containers 301.

Multiple delivery containers 201 may be utilized according to the invention. That is, multiple delivery containers 201 may be maintained in a distribution facility, and/or a delivery vehicle may carry multiple deliver containers 201 for use in transporting food oil to locales such as restaurants or other commercial or private establishments.

In a preferred embodiment, delivery container 201 is formed in two parts: a delivery container body 231 and a delivery container support structure 233. Delivery container body 231 may be formed of any suitable material. In an exemplary embodiment, delivery container body 231 is preferably formed of thermoplastic, thermosetting plastic, and/or metal materials such as polyamide, polypropylene, HDPE, melamine formaldehyde, aluminum, stainless steel, or combinations of the above. Delivery container body 231 may be formed in any useful shape. In a preferred embodiment, deliver container is formed, for example, in a cubic or rectangular shape for efficient storage with additional like-sized and/or like-shaped containers. Generally, delivery container 201 also includes delivery container input 203 for providing food oil to delivery container 201, and delivery container output 221 for removing oil from delivery container 201.

Delivery container output 221 is in fluid connection with an output nozzle, such as output nozzle 229. It is understood that the term “output nozzle” as utilized herein is construed broadly to include any useful mechanism to delivery food oil from delivery container 201 to another container, for example various forms of mechanical or electrical valves, mechanical or electrical nozzles. An “output nozzle” may be directly connected with delivery container 201, or may be in fluid connection through an intermediate component such as a hose or pipe.

Delivery container support structure 233 is preferably formed as a series of metal bars forming a cage structure that generally encloses and protects delivery container body 231 from impact, deformation or similar stresses. Delivery container support structure 233 may be formed of any useful material. In a preferred embodiment it is formed of metal, for example stainless steel or aluminum.

Other exemplary features of delivery container 201 are described herein with respect to the preferred embodiment of FIG. 2, which includes delivery container body 231 and delivery container support structure 233, but it is understood that the various features described herein may be selectively utilized, as useful or desirable, with other embodiments of a delivery container 201 according to the invention.

In particular, delivery container input 203 may be located in any useful location on delivery container 201, but preferably is located on or near a top surface. Input 203 may include a removable cover or closure (not shown) to allow selective access to delivery container 201. It is understood that “removable” as used herein includes arrangements, for example hinged arrangement, in which the cover or closure is still attached to delivery container 201; as well as arrangement, such as a threaded arrangement, in which the cover or closure is completely detached from delivery container 201.

In an exemplary embodiment, delivery container output 221 may feed output hose 223, which provides fluid communication for food oil to a pump 225. In an exemplary embodiment, delivery container input 203 may be co-extensive with delivery container output 221, so that disconnecting or removing output hose 223 and/or all or part of delivery container output 221 allows access to delivery container 201 for refilling.

Pump 225 may, for example, be connected at the downstream end with nozzle hose 227, which terminates at output nozzle 229. Output nozzle 229 may preferably be a hand-operated nozzle similar to a vehicular fuel dispensing nozzle, but any useful nozzle or other terminating feature may be utilized with delivery container 221.

In a further preferred embodiment, delivery meter 228 is provided, for example in line with nozzle 229, to provide an indication of the amount of food oil delivered. Deliver meter 228 may be any useful meter, but in a preferred embodiment may be a digital or analog flow meter such as a rotameter.

In a further preferred embodiment, delivery container 221 may include casters 251 for convenient movement within a location or between locations.

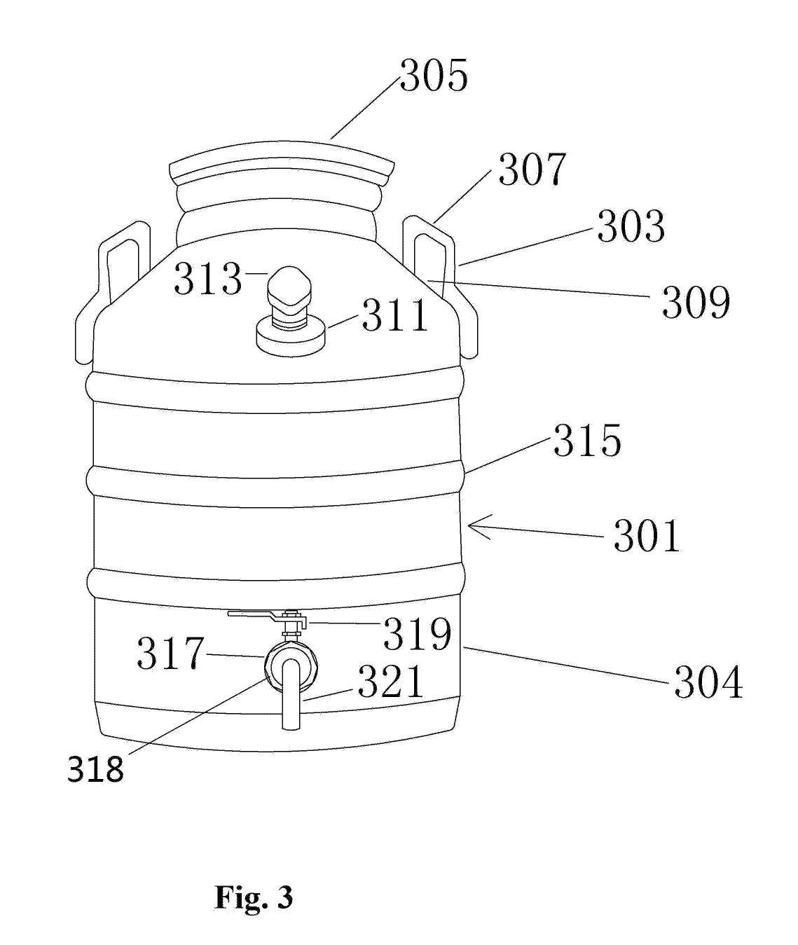

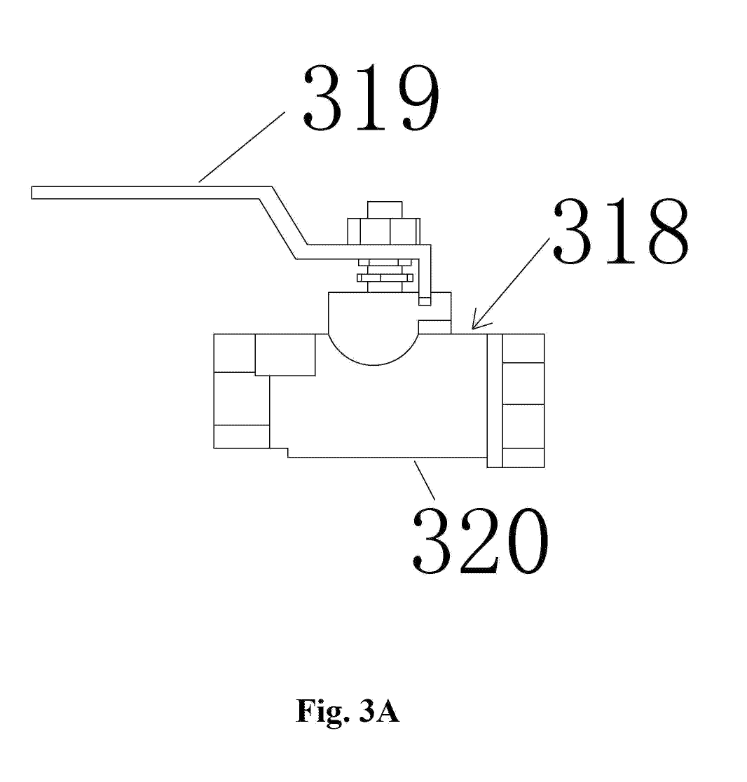

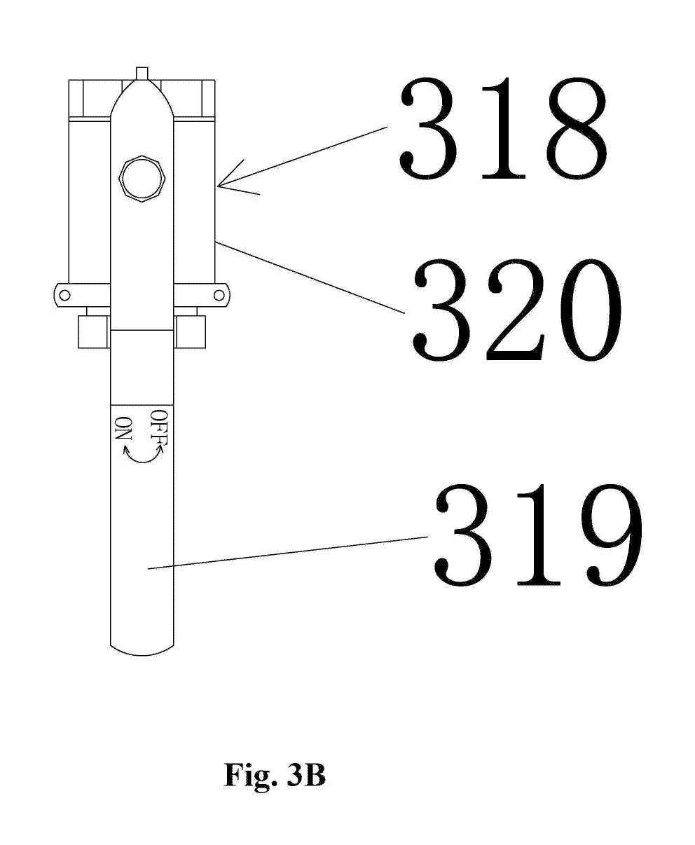

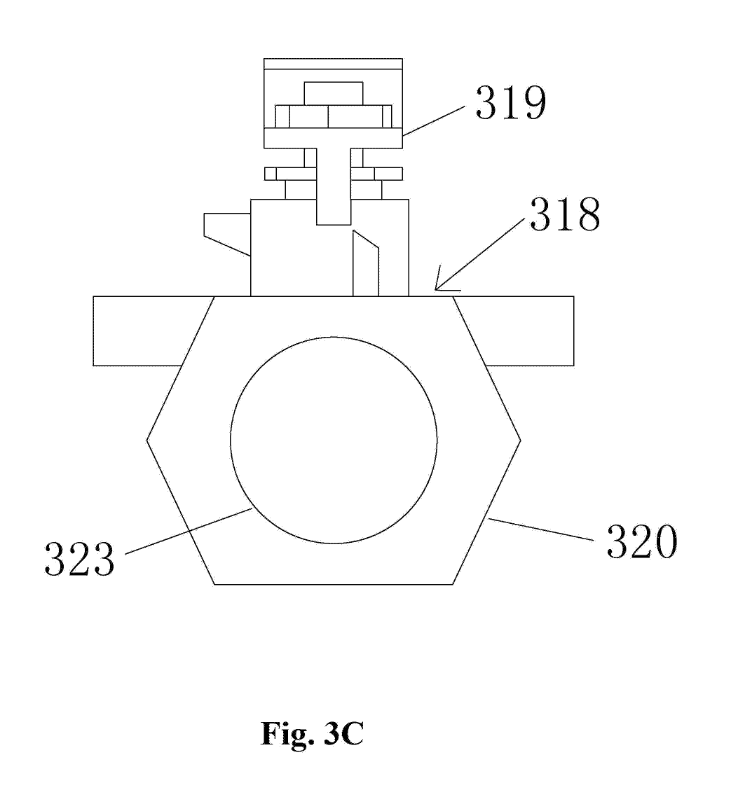

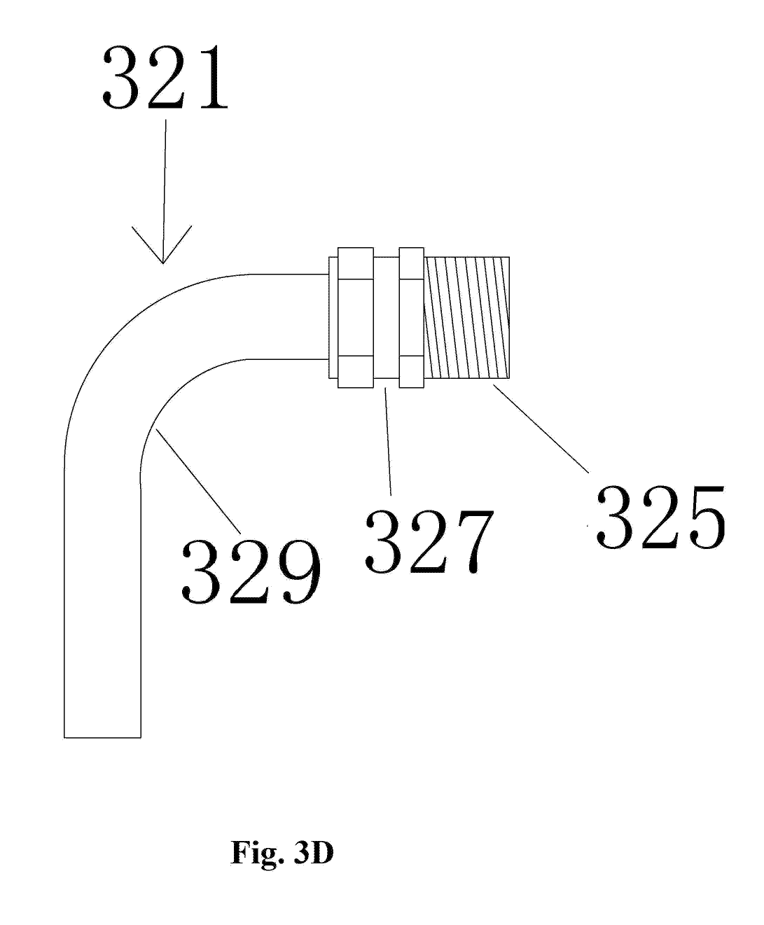

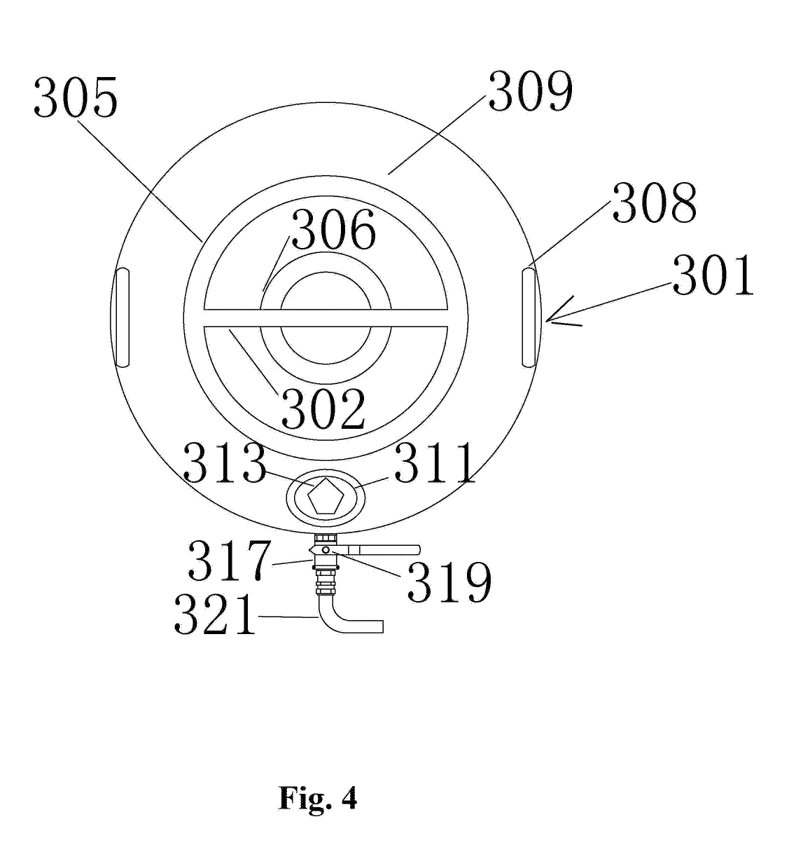

FIGS. 3 and 4 show an exemplary storage container 301 for food oil according to the present invention. Storage container 301 may be of any useful size, but in a preferred embodiment may store between 10 and 100 liters of food oil. In further preferred embodiments, storage container 301 may store approximately 30 to approximately 50 liters. In particular preferred embodiments, storage container 301 may store approximately 30 liters or approximately 50 liters of food oil.

Storage container 301 may be constructed of any useful material or materials. In a preferred embodiment, storage container is formed of a metal such as stainless steel, or a thermosetting plastic and/or thermoplastic material as identified above (recognizing that various components of storage container 301 may be formed of a variety of such materials).

Exemplary storage container 301 is generally cylindrical or drum-shaped, and may include an upper portion 303 and lower portion 304. It is understood that any useful shape of storage container 301 may be utilized for storing food oil. Storage container 301 may include, for example at the upper portion 303, an access opening 305 that is selectively accessed by an access lid 306. Preferably, access lid 306 and access opening 305 are threaded, but any useful engagement or fitting feature may be utilized, for example clasps, friction fit, and the like. Access lid may include an access handle 307, with which storage container 301 may be lifted, shifted, and/or transported. Preferably access lid 306 is formed of the same material as main body of storage container 301, but any useful material may be utilized.

Storage container may also include storage container input 311, along with input plug 313. Storage container input 311 may be of any useful size that would allow filling and/or re-filling of storage container 301 with food oil. Preferably, storage container input 311 is constructed a suitable size and shape to cooperate with nozzle 229 of delivery container 201. In this way, food oil may efficiently and conveniently be provided from delivery container 201 to storage container 301, while reducing effort, waste and/or spillage. In a preferred embodiment, storage container input may include a fill plug of an appropriate size, a particularly preferred size being approximately 1.0 inches; along with a pipe coupling of an appropriate size, a particularly preferred size being approximately 1.0 inches.

Storage container input 311 and input plug 313 may be constructed to cooperate in any manner that would allow input plug 313 to be selectively removed from storage container input 311, thereby allowing access to storage container input 311.

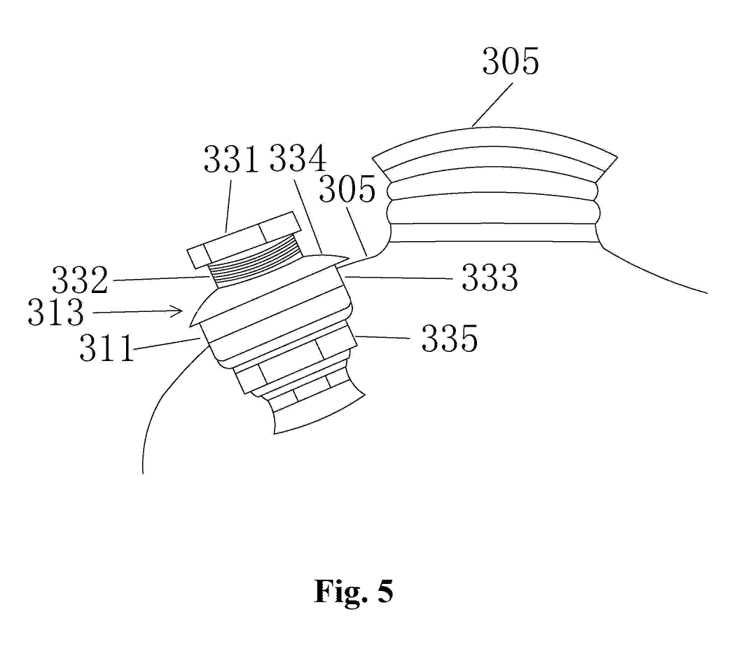

Preferred embodiments of storage container input 311 and input plug 313 are shown in FIG. 5. In these preferred embodiments, storage container input 311 and input plug 313 are both threaded, with input thread 333 of storage container input 311 cooperating with plug thread 334 of input plug 313. In this embodiment, input plug 313 may further be formed with a hex head 331 or other bolt-style head, to allow efficient opening and closing by rotation, using a wrench or other suitable tool. Alternatively, input plug 313 may include a recessed feature such as an Allen or hex keyhole, Phillips head or slotted head, to facilitate opening and closing by rotation of input plug 313. In a preferred embodiment, input plug 313 further includes a through-hole, for example a one-eighth inch through hole, for venting.

In the exemplary embodiment of FIG. 5, the hex head 331 (or other feature) is maintained away from the surface of storage container 301 and storage container input 311 by neck 332 and or shoulder 336 (for example the rounded shoulder 336 as shown in FIG. 5). This may provide space for ease of manipulation of input plug 313. In some instances, such features may not be desirable. As just one example, the location and surrounding area of storage container 301 may make turning such an input plug 313 difficult.

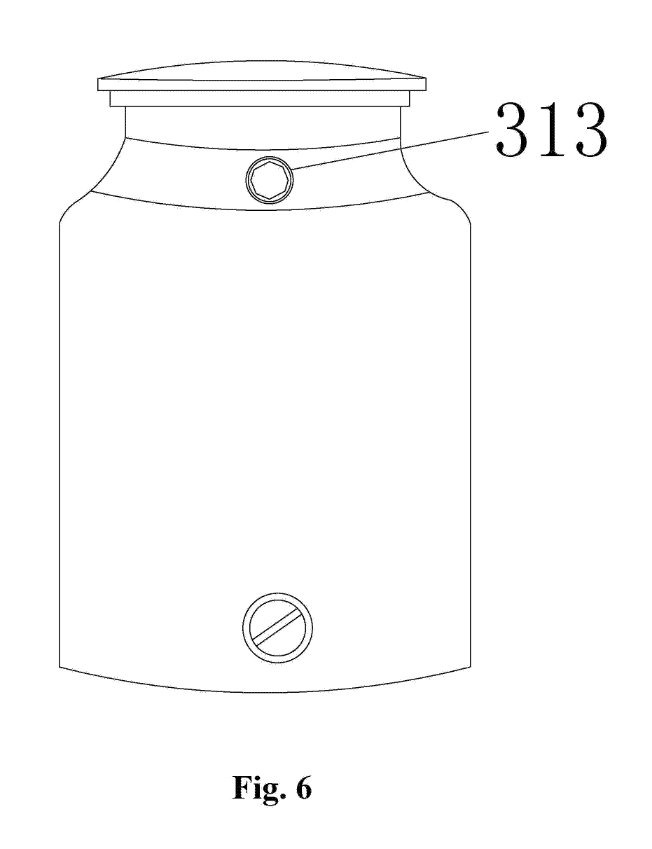

FIG. 6 illustrates an alternative embodiment of input plug 313. In the alternative embodiment of FIG. 6, input plug 313 is formed without neck 332 and/or shoulder 336, so that input plug 313 is substantially flush with storage container 301. It is understood that “substantially flush” includes configurations in which hex head 331 (or other feature) extends peripherally from storage container 301 by at least the depth of hex head 331.

As with other components, storage container input 311 and input plug 313 may be formed of any useful material, but preferred embodiments are formed of stainless steel or a thermoplastic material.

As variously shown in FIGS. 3-5, in a preferred embodiment, storage container input 311 and input plug 313 may be located on an angled shoulder 309 of storage container 301. Shoulder 309 may be located, for example, on upper portion 303 of storage container 301, below access opening 305. Storage container 301 may also include one or more lift handles 307, which may preferably be located adjacent to shoulder 309. Lift handle(s) 307 may be formed of any useful material, but preferred embodiments are formed of metal such as stainless steel or a thermoplastic material. Lift handle(s) 307 may be formed integrally with storage container 301, or may be formed separately and then attached in any useful manner, for example via bolts or via welding.

In another exemplary embodiment, as shown in FIG. 3, storage container 301 may also include one or more circumferential ribs 315 to provide strength and/or rigidity. Preferably a plurality of ribs 315 are provided, spaced apart vertically along storage container 301.

Storage container 301 also preferably includes a storage container output 317, which may be located for example on lower portion 304 of storage container 301. In a preferred embodiment, storage container output 317 includes a valve 318 including an exemplary valve handle 319 that operates the valve. Valve 318 selectively permits the flow of food oil from storage container 301. In a further preferred embodiment, storage container output 317 includes a spout 321. Spout 321 may be formed in any suitable shape or configuration to allow easy and efficient dispensation of food oil to any sort of container, food product, serving implement, plate, etc (collectively referred to herein for convenience as “food preparation equipment”). Spout 321 may also be rotatable and/or bendable to further facilitate dispensing food oil, and/or to assist preventing the flow of oil when not desired (for example by rotating spout 321 so that it points upward when not in use).

FIGS. 3A, 3B and 3C show an exemplary valve 318 that may be utilized with the present invention, which preferably includes valve body 320 and valve handle 319. FIG. 3D shows an exemplary spout 321 that may be utilized with the present invention. An interior surface of valve body 320 may include internal threads 323 (not shown, but location identified in FIG. 3C), which cooperate with external threads 325 on spout 321. Spout 321 further preferably includes spout neck 329 that directs food oil into a desired container, dish or other useful item or area. Spout 321 may also preferably include a rotatable hinge 327 to allow rotation of spout neck 329 relative to the remainder of the assembly, as described above.

In a preferred embodiment, storage container output 317 is formed with a pipe nipple of an appropriate size, a particularly preferred size being approximately 0.5 inches; ball valve (shown as 317) of an appropriate size, a particularly preferred size being approximately 0.5 inch NPT (National Pipe Thread); and a storage output plug of an appropriate size, a particularly preferred size being approximately 0.5 inch NPT. As noted above, these may be formed of any useful material, but preferred materials include metals such as stainless steel. In an alternate embodiment, storage container output may include a flapper valve spigot.

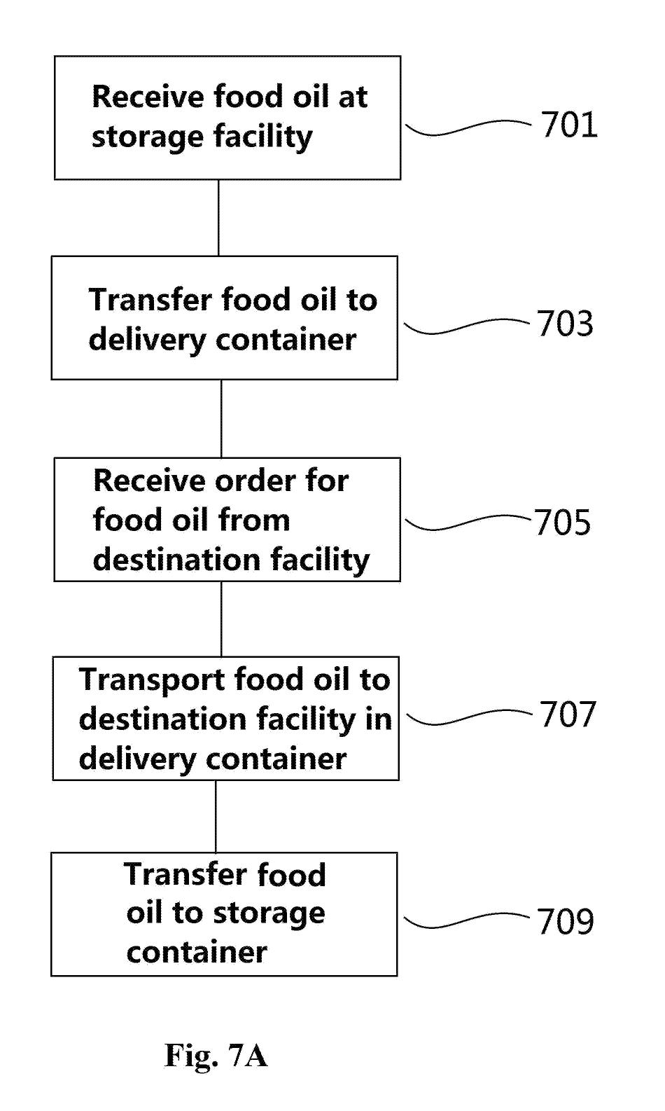

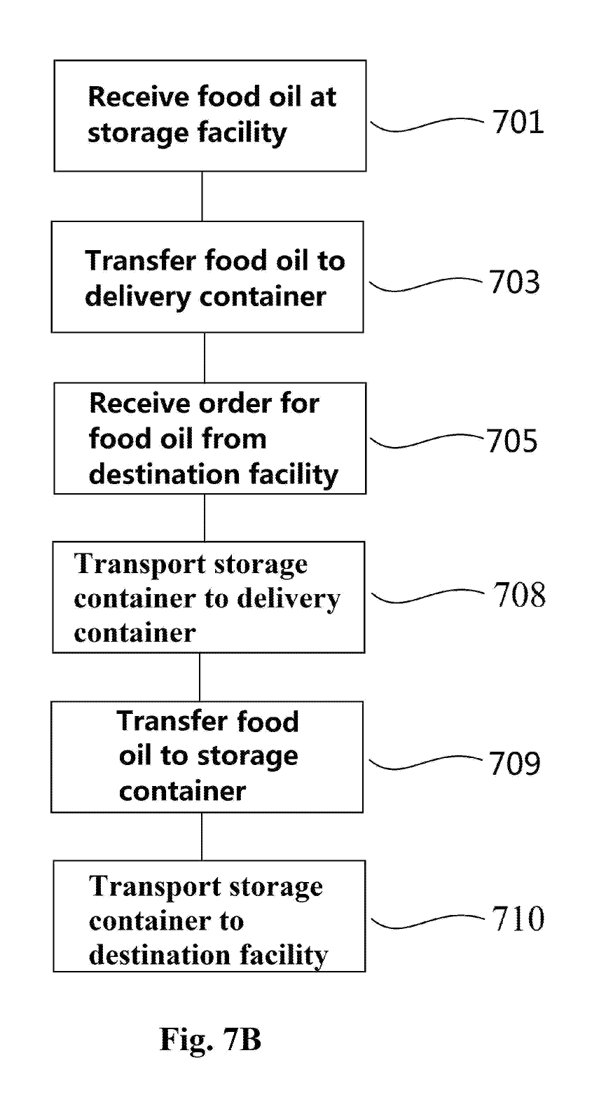

FIGS. 7A and 7B show exemplary methods of providing and/or storing food oil according to the present invention. It should be understood that, generally, for the exemplary methods elucidated in FIGS. 7A and/or 7B, the order of steps may vary from that shown. In the same manner, the order of steps recited in any claim below may also vary as desired or useful. Moreover, in each exemplary method of FIGS. 7A and 7B, certain steps may be omitted as desired, or additional steps included. Such variance is understood to be within the scope of the invention.

In the exemplary method of FIG. 7A, food oil is received at a storage facility in step 701. It is understood that the term “storage facility” is construed broadly, to include any type of storage location or mechanism, particularly those designed to handle and/or store large volumes of fluid. It is further understood that a storage drum 101 as described above may constitute such a storage facility, or may be part of such a storage facility.

In exemplary step 703, food oil is transferred from a storage facility (such as or including a storage drum 101) to a delivery container 201. It is understood that any delivery container 201 described herein may be utilized as a delivery container within step 703. In an alternate embodiment, other delivery vessels such as tankers may be utilized. Further, it is understood that step 703 may include embodiments in which food oil is provided to delivery container 201 directly from means other than a storage facility. For example, food oil may be provided to a delivery container 201 directly from rail car, shipping container, tanker truck or other suitable means. Each of these embodiments is understood to be included within step 703 of FIG. 7A (and of FIG. 7B, as set forth below).

In exemplary step 705, an order for food oil is received from a destination facility (such as a restaurant or other commercial establishment, or a private establishment). It is understood in particular that this step may occur at any point in the described method, or at various points in the described method, or before or after all other steps of the described method. It is further understood that the term “order” is construed broadly, to including any indication from a destination facility that food oil is required or desirable. Such orders may, for example, take place substantially contemporaneously (i.e., within days) of one or more other steps of the method, or distant in time. Such orders also include, for example, recurring, automatic, or prescheduled deliveries of food oil.

In exemplary step 707, food oil is transported to the destination facility within delivery container 201. This may be accomplished in any useful or desirable manner as understood within the art. In a preferred embodiment, one or more delivery containers 201 are carried by truck or other motor vehicle.

In exemplary step 709, food oil is transferred to a storage container 301. It is understood that any storage container 301 as described herein may be utilized as a storage container within step 709. With food oil in storage container 301, the food oil may be utilized in any desired manner within the destination facility.

In the exemplary method of FIG. 7B, steps sharing reference numerals with FIG. 7A may be performed as described above. The exemplary method of FIG. 7B, however, provides an alternative to step 707, which involves the transportation of delivery container(s) 201 to storage container(s) 301. Instead, in step 708 of FIG. 7B, one or more storage containers 301 are transported to one or more delivery containers 201. This may be accomplished in any useful or desirable manner as understood within the art. In a preferred embodiment, one or more storage containers 301 are carried by truck or other motor vehicle. In step 710, one or more storage containers 301 are returned to the destination facility.

In each exemplary method according to the present invention, storage container 301 may be refilled using like steps, to avoid waste and decrease costs.

It should be noted that the above-mentioned embodiments illustrate rather than limit the invention, and that those skilled in the art will be able to design many alternative embodiments without departing from the scope of the appended claims. Various aspects of the invention shown in any of the Figures may be optionally combined with aspects shown in one or more other Figures. The exemplary description and Figures set forth herein provide some examples of such variation, combination, substitution and/or omission, but it is understood that any other useful or desired combination of such features is within the scope of the invention. Use of the term “comprise” or “comprising” and their conjugations does not exclude the presence of elements or steps other than those stated in a claim. The article “a” or “an” preceding an element does not exclude the presence of a plurality of such elements. As further described above, the invention may be implemented by means of components comprising several distinct elements or elements formed unitarily. The fact that certain features are recited in mutually different dependent claims does not indicate that a combination of these features cannot be used to advantage. All such variants apparent to one of ordinary skill in the art based on the above disclosures should be considered within the scope of the invention.

What is claimed is:

1. A food oil delivery and storage system, comprising:
a delivery container, the delivery container further comprising a delivery container output for dispensing food oil, the delivery container output in fluid communication with a delivery nozzle; and
a storage container; the storage container further comprising:
a storage container input disposed on an upper portion of the storage container, the storage container input configured to receive cooking oil from the delivery nozzle, and storage container input including a removable plug; and
a storage container output for dispensing food oil to food preparation equipment, the storage container output disposed on a lower portion of the storage container, the storage container output including a controllable valve for selectively dispensing food oil to the food preparation equipment.

2. The food oil delivery and storage system of claim 1, wherein the storage container further includes:
an access opening at a top surface of the storage container, the access opening including a threaded interior surface; and
an access lid, the access lid including a threaded exterior surface cooperating with the threaded interior surface of the access opening.

3. The food oil delivery and storage system of claim 1, wherein the storage container further includes at least one lift handle and at least one circumferential rib.

4. The food oil delivery and storage system of claim 1, wherein the storage container is between approximately 30 liters and approximately 50 liters in size.

5. The food oil delivery and storage system of claim 1, wherein the storage container output further includes a valve, a valve handle and a spout.

6. The food oil delivery and storage system of claim 5, wherein the spout is rotatable.

7. The food oil delivery and storage system of claim 1, wherein the delivery container further includes:
a pump;
an output hose connecting the storage container output and the pump;
a nozzle hose connecting the pump to the output nozzle; and
a delivery meter that tracks the flow of fluid through the output nozzle.

8. The food oil delivery and storage system of claim 1, wherein the delivery container is between 400 and 2000 liters in size.

9. The food oil delivery and storage system of claim 1, the delivery container further including a delivery container input.

10. The food oil delivery and storage system of claim 1, further including at least one storage drum for storing food oil and providing food oil to the delivery container.

11. A method of storing and delivering food oil, comprising:
providing food oil to a delivery container;
transferring food oil from the delivery container to a storage container;
subsequently transferring additional food oil from the delivery container to the storage container.

12. The method according to claim 11, wherein the delivery container is between 200 and 4000 liters in size, and the storage container is between 10 and 100 liters in size.

13. The method according to claim 11, further comprising transporting the delivery container to the storage container before transferring food oil from the delivery container to the storage container.

14. The method according to claim 11, further comprising transporting the storage container to the delivery container before transferring food oil from the delivery container to the storage container.

15. The method according to claim 14, further comprising transporting the storage container to a destination facility after transferring food oil from the delivery container to the storage container.

16. The method according to claim 11, wherein the delivery container further includes:
a storage container output;
a pump;
an output hose connecting the storage container output and the pump;
a nozzle;
a nozzle hose connecting the pump to the output nozzle; and
a delivery meter that tracks the flow of fluid through the output nozzle;
wherein the step of transferring food oil from the delivery container to a storage container further includes transferring food oil through the pump and the nozzle.

17. The method according to claim 11, further comprising:
providing food oil to a storage drum;
and wherein the step of providing food oil to the delivery container comprises transferring food oil from the storage drum to the delivery container.

18. The method according to claim 17, further comprising transporting the delivery container to the storage container before transferring food oil from the delivery container to the storage container.

19. The method according to claim 17, further comprising transporting the storage container to the delivery container before transferring food oil from the delivery container to the storage container.

20. The method according to claim 11, further comprising transferring food oil from the storage container to food preparation equipment.
